(19) United States
(12) Patent Application Publication
(10) Pub. No.: US 2025/0237863 A1
(43) Pub. Date: Jul. 24, 2025

(54) NIGHT VISION INSTRUMENT FOCUS DEVICE

(71) Applicant: Phokus Research Group, LLC, San Diego, CA (US)

(72) Inventor: Robert J. Hanna, San Diego, CA (US)

(21) Appl. No.: 19/034,498

(22) Filed: Jan. 22, 2025

Related U.S. Application Data
(60) Provisional application No. 63/623,783, filed on Jan. 22, 2024.

(51) Int. Cl. G02B 27/00; G02B 5/00

(52) U.S. Cl. CPC G02B 27/0081; G02B 5/005

(57) ABSTRACT

Provided is a device for improving the focus of an object viewed using a night vision instrument.

### CROSS REFERENCE

The present application claims the benefit of U.S. Provisional Application 63/623,783 filed 22 Jan. 2024; which is incorporated herein by reference in its entirety.

### TECHNICAL FIELD

The present invention relates to night vision instruments, and more particularly, to devices for improving the focus of an image produced by a night vision instrument and methods of using those devices.

### BACKGROUND OF THE INVENTION

The subject invention generally relates to night vision instrument such as night vision goggles. Night vision goggles are typically set to focus at a certain distance. Operators usually adjust the focus for viewing objects far from the operator. This makes anything close to the operator appear blurry. It would be advantageous, therefore, to increase visual clarity for near objects and far objects without having to make adjustments on the night vision goggle itself. It would also be advantageous if one could modify an existing night vision instrument with a device for improving the image clarity for near objects, but be able to quickly and easily revert back and forth between the modified night vision goggle and night vision goggle operation as designed by its manufacturer. The present invention addresses those needs.

### SUMMARY

Provided is a device for improving the focus of an object viewed using a night vision instrument, where the night vision instrument comprises an instrument lens, a lens frame comprising a distal end, and night vision components. The device comprises a housing configured to attach to the distal end of the lens frame and a cover coupled to the housing. When the housing is attached to the lens frame, the cover is adjustable to define an aperture allowing light to the lens, the aperture being variable between having at least a first area and a second area, the first area being smaller than the second area; wherein when the device is attached to the night vision instrument, the visual clarity of the object viewed through the instrument and device is superior to the visual clarity of the object when viewed using the instrument without the device, when the object is within 3 feet of the device and the aperture has the first area. In certain embodiments, the device does not comprise a device lens. In certain embodiments, the device includes a filter, sacrificial filter, or protective element, not comprising a lens, to protect the night vision instrument lens.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is an exploded view of a device for improving the focus of an image produced by a night vision instrument in accordance with the principles of the invention.

FIG. 2 is an assembled view of the device connected to the night vision instrument wherein the device is in a closed state.

FIG. 3 is an assembled view of the device connected to the night vision instrument wherein the device is in an open state.

FIG. 4 is a front view of the device for improving the focus of an image produced by a night vision instrument.

FIG. 5 is a back view of the device for improving the focus of an image produced by a night vision instrument.

FIG. 6 is an illustration of the device illustrating an alternative securing mechanism for securing the device to a night vision instrument.

FIG. 7 is a illustration of a device having a panel in permanently fixed orientation with the side of the device.

FIG. 8 is an assembled view of alternate embodiment of the device.

FIG. 9 is an exploded view of an alternate embodiment of the device.

FIG. 10 is a flow chart of a method for operating a night vision instrument for viewing a near object, when the night vision instrument has a focus optimally set to view distant objects.

FIG. 11 is a flow chart of a method for operating a binocular night vision instrument, in accordance with the principles of the invention.

FIG. 12 is a block diagram of an improved night vision instrument configured with an embodiment of the present invention.

FIG. 13 is an illustration of the Snellen eye chart and Lea test chart.

FIGS. 14A-14H are bar graphs showing the effect of no aperture (FIGS. 14A and 14B), and apertures of 1/16″ (FIGS. 14C and 14D), ⅛″ (FIGS. 14E and 14F) or 13/64″ (FIGS. 14G and 14H) on the ability to focus (visual clarity) using either the Snellen eye chart (FIGS. 14A, 14C, 14E and 14G) or the Lea test (FIGS. 14B, 14D, 14F and 14H) in the presence or absence of an infrared light source.

FIG. 15A is another front view of the device illustrating an alternative cover for providing an aperture in accordance with some embodiments of the present disclosure. FIG. 15B is a rear view of the cover illustrating the aperture selection ring, the aperture, and various aperture adjustments.

FIG. 16 is a cross-section of FIG. 15A and illustrates a locking mechanism of the aperture selection ring in accordance with some embodiments of the present disclosure.

FIG. 17 is another cross-section of FIG. 15A and illustrates an alternative locking mechanism of the aperture selection ring in accordance with some embodiments of the present disclosure.

FIG. 18 illustrates an example of an excerpt of a user manual for the night vision instrument.

FIG. 19 is a perspective view of an aperture selection ring according to a new design.

FIG. 20 is a front view of aperture selection ring according to the new design.

FIG. 21 is a rear view of aperture selection ring according to the new design.

FIG. 22 is a left view of aperture selection ring according to the new design.

FIG. 23 is a right view of aperture selection ring according to the new design.

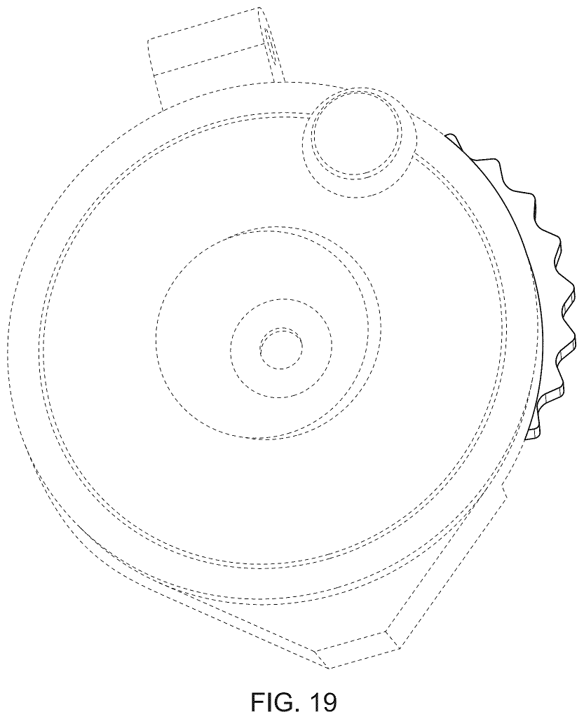

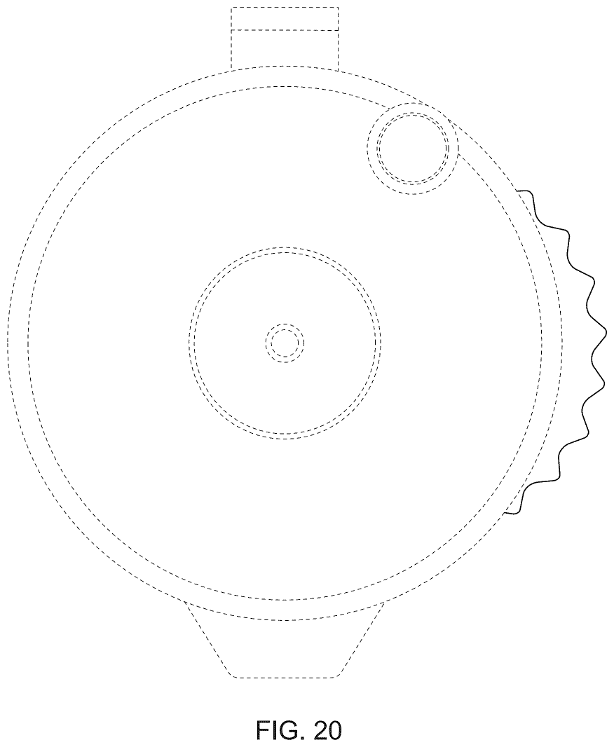

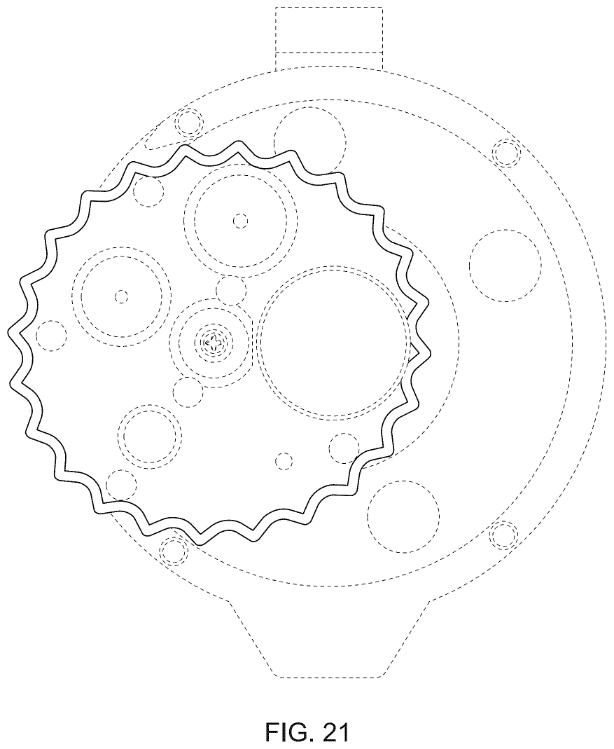

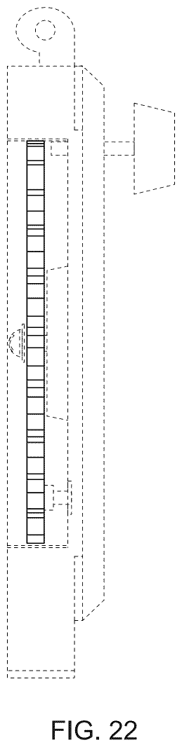

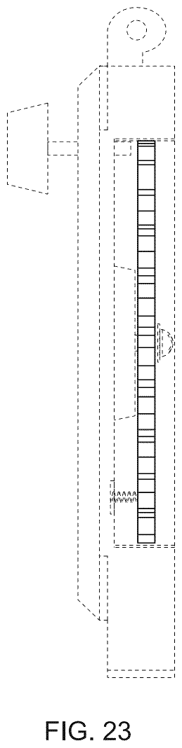

FIGS. 19-23 include broken lines shown for the purpose of illustrating portions of the cover and form no part of the claimed design.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION

From time-to-time, the present invention is described herein in terms of example embodiments. Description in terms of these embodiments is provided to allow the various features and embodiments of the invention to be portrayed in the context of an exemplary application. After reading this description, it will become apparent to one of ordinary skill in the art how the invention can be implemented in different and alternative embodiments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

In some embodiments, a device is provided for improving the focus of an object viewed using a night vision instrument, where the night vision instrument comprises an instrument lens, a lens frame comprising a distal end, and night vision components. The device comprises a housing configured to attach to the distal end of the lens frame and a cover coupled to the housing. When the housing is attached to the lens frame, the cover is adjustable to define an aperture allowing light to the lens, the aperture being variable between having at least a first area and a second area, the first area being smaller than the second area; wherein when the device is attached to the night vision instrument, the visual clarity of the object viewed through the instrument and device is superior to the visual clarity of the object when viewed using the instrument without the device, when the object is within 3 feet of the device and the aperture has the first area. In one or more embodiments, when the housing or the cover is attached to the lens frame, the cover is adjustable to define a plurality of apertures allowing light to the lens, the plurality of apertures being variable between having at least a first area and a second area, the first area being smaller than the second area; wherein when the device is attached to the night vision instrument and the cover is adjusted to a first aperture or a second aperture, the visual clarity of the object viewed through the instrument and device is superior to the visual clarity of the object when viewed using the instrument where the cover is adjusted to a third aperture, when the object is within 3 feet of the device. In certain embodiments, the device does not comprise a device lens. In certain embodiments, the device comprises or includes a sacrificial filter.

In one or more embodiments, when the housing or the cover is attached to the lens frame, the cover is adjustable to define a plurality of apertures allowing light to the lens, the plurality of apertures being variable between having at least a first area and a second area, the first area being smaller than the second area; wherein when the device is attached to the night vision instrument and the cover is adjusted to a first aperture, the visual clarity of the object viewed through the instrument and device is superior to the visual clarity of the object when viewed using the instrument where the cover is adjusted to a second aperture, when the object is within 3 feet of the device.

It is noted that devices previously described for improving close vision for night vision instruments require a lens. See U.S. Pat. Nos. 4,376,889; 5,175,651; 5,617,257 and 5,760,953. The devices described herein have the advantage of not requiring a device lens (i.e., a lens associated with the device, as opposed to the instrument lens, which is a lens integral to a night vision instrument). The instrument lens is the lens of the night vision instrument that is the most distal lens (i.e., the furthest from the instrument user) of the instrument. As such, the instrument lens is the first lens of a night vision instrument to encounter light from the environment. The instrument lens focuses that light to be further processed in more proximal (i.e., closer to the instrument user) lenses and other components in the instrument.

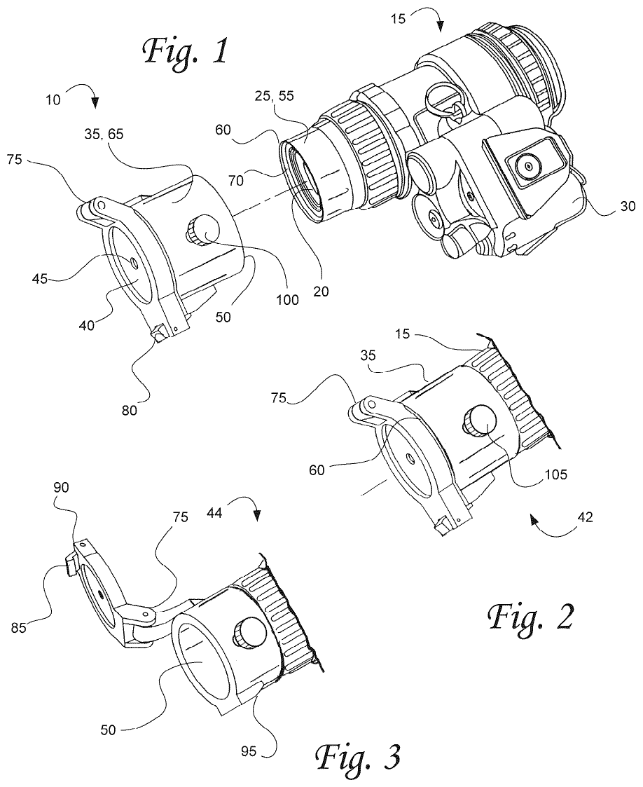

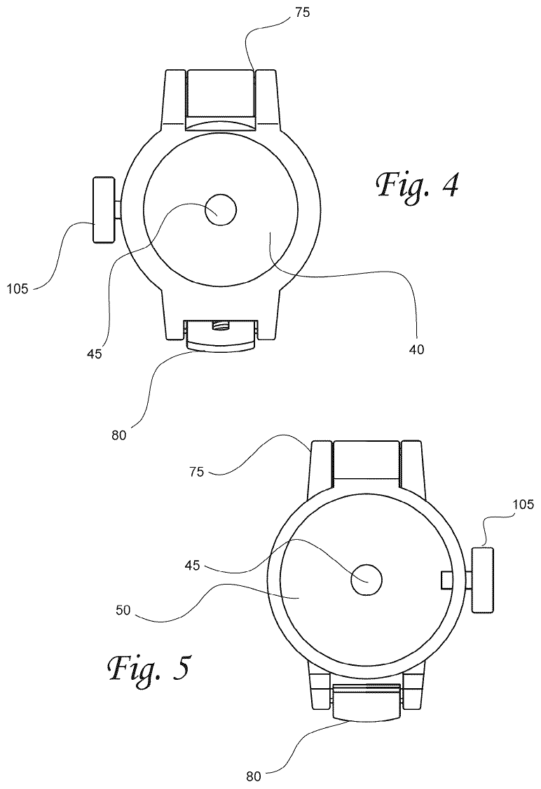

Referring now to FIGS. 1-5, in some embodiments, a device 10 for improving the focus of an image produced by a night vision instrument 15. The night vision instrument 15 may comprise a lens 20, a lens frame 25 and night vision components 30. The device 10 comprises a housing 35 configured to attach to the lens frame 25 and a front panel 40 coupled to the housing 35. The front panel is also defined herein as a cover. The front panel 40 may be manually adjustable between an open state 44 (see e.g. FIG. 3) and a closed state 42 (see e.g. FIG. 2) by a user of the night vision instrument 15. One or more apertures 45, or an aperture 45 that is adjustable to different sizes is disposed in the front panel 40. In these embodiments, the open state is the state where the aperture is more generally defined as having a second area, either by adjusting the location of the front panel 40 away from or not in front of the lens 20 or by adjusting the size of the aperture 45; the closed state is the state wherein the aperture 45 is more generally defined as having a first area or being disposed in front of or over the lens 20. The one or more apertures 45 or the aperture 45 is configured for viewing objects therethrough.

In one or more embodiments, the open state is the state where the aperture is more generally defined as having a second area or a third area, either by adjusting the location of the front panel 40 away from or not in front of the lens 20 or by adjusting the size of the aperture 45.

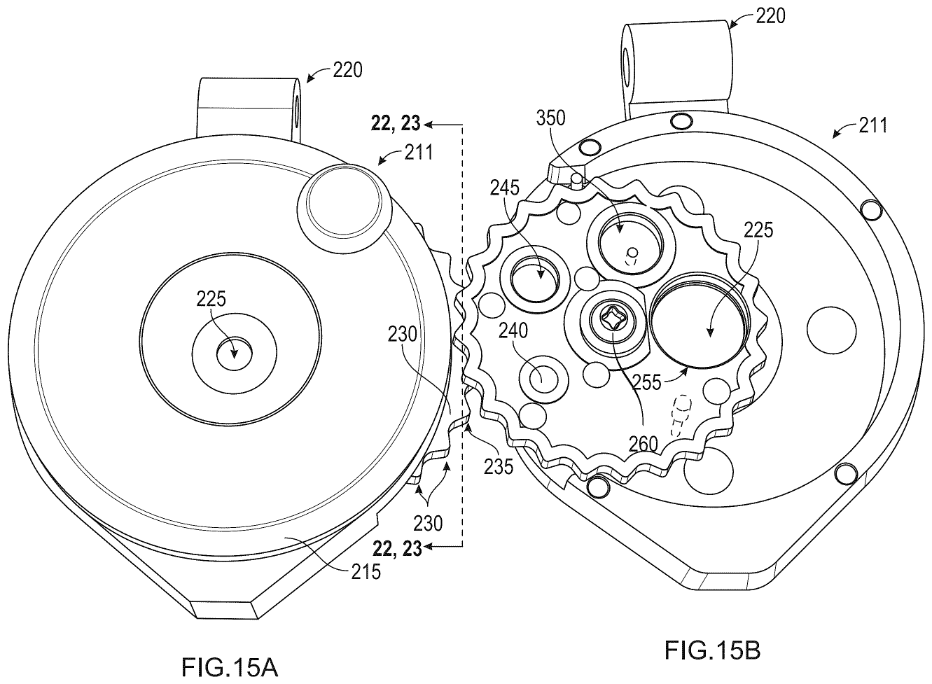

The devices are not narrowly limited to any particular size of an aperture 45 having a first area or a second area, or additional areas. The aperture size defined herein as the first area or the second area should be selected to permit a sufficient amount of light to pass through to permit the night vision instrument to operate suitably for the user's purpose, yet achieve improvement in the focus images produced by the night vision instrument 15. The skilled artisan, with consideration of the teachings herein, could select without undue experimentation an appropriate aperture first area or second area suited for any particular purpose without undue experimentation. See, e.g., Example 1. As established therein, an aperture having a smaller area allows improved visual clarity at closer distances than an aperture having a larger area. A smaller aperture also allows less light to reach the instrument than a larger aperture. The user would thus balance the amount of light needed for adequate vision with the distance where visual clarity is most desired in selecting the aperture most appropriate for the task at hand. Depending on the device configuration, the device could comprise replaceable covers with different apertures, or the aperture area could be adjustable to a plurality of diameters within a single cover. See, e.g., the cover illustrated in FIG. 15, described further below. In some embodiments, the first area has a maximum diameter of about 13/64″ or less. In more specific embodiments, the first area has a maximum diameter of about ⅛″ or less, e.g., 1/16″.

In the embodiments illustrated in FIGS. 1-9, the cover 40 comprises an opening or aperture 45 having the first area. The cover further comprises one hinge 75 connecting the cover 40 to the housing 35. Superior visual clarity is achieved by swinging the cover 40 over the instrument lens frame 25 to allow light to the instrument lens 20 having the first area. The opening or aperture 45 having the second area is achieved by either swinging the cover 40 away from the lens frame 25 or rotating an aperture ring (as shown in FIG. 15) to position a second hole having a larger diameter in the opening or aperture 45. Thus, the second area in these embodiments is equal to either the area of the instrument lens without the device or the diameter of the second hole. Alternatively, the opening or aperture 45 having the second area is achieved by rotating an aperture ring (as shown in FIG. 15) to position a second hole having a larger diameter in the opening or aperture 45. A third area is achieved by swinging the cover 40 away from the lens frame 25.

These embodiments are also not limited to any particular distance between the cover and the instrument lens. The skilled artisan, with consideration of the teachings herein, could select an appropriate distance for any particular purpose without undue experimentation. See, e.g., Example 2, showing that the horizontal field of view increases with decreased distance from the instrument lens. In some embodiments, the cover is about 10/16″ or less from the instrument lens. In other embodiments, the cover is about 3/16″ or less from the instrument lens, e.g., 2/16″. In some embodiments, the cover is disposed at the distal end of the lens frame. The distance from the lens can be adjusted by, e.g., placing a spacer between the lens frame and the cover, or providing a housing that can be set to provide various distances between the lens frame and the cover.

In the embodiments illustrated in FIGS. 1-9, the aperture having the first area 45 is circular. However, the aperture having the first area can be any other shape, e.g., a triangle, a square, a parallelogram, a pentagon, a hexagon, a heptagon, an octagon, a star, etc. Similarly, in the embodiments illustrated in FIGS. 1-9, the front panel (i.e., the cover) is circular. However, the cover can be any shape as appropriate.

FIG. 1 illustrates the device aligned to become attached to the night vision instrument. FIG. 2 illustrates the device attached to the night vision instrument in a closed state. An advantage of the device 10 is it can reduce glare caused by ambient visible light sources, to a manageable level by the operator of the night vision instrument.

In one embodiment, when the device 10 for improving the focus of an image is attached to the night vision instrument 15, the user may optionally toggle the device between the open 44 (i.e., the aperture having the second area) and the closed 42 (i.e., the aperture having the first area) states. When the device is in the closed state 42 and attached to the night vision instrument 15, the image captured by the night vision instrument 15 is filtered by the aperture 45 (i.e., allows light to the lens) and the focus of the image viewed by the user through the night vision instrument 15 (i.e., the visual clarity of an object viewed through the instrument) is improved.

In a variant of the device 10 for improving the focus of an image produced by a night vision instrument 15, the housing 35 comprises a cavity 50 configured to conform to an outside surface 55 of the lens frame 25 of the night vision instrument 15. Optionally, the housing 35 may be cylindrical in shape to conform to the typical shape of the lens frame 25 of the typical night vision instrument 15. The conformation of the housing to the outside of the lens frame 25 enables the device 10 to attach to the lens frame 25. The housing 35 is configured to hold the front panel 40 containing the aperture or plurality of apertures 45 in parallel spatial relationship with the lens 20, when the device 10 is attached to the lens frame 25 and in a closed state 42. In some embodiments, the device is configured to position the aperture or plurality of apertures 45 as close as possible to the lens 20 without damaging the lens.

In another variant of the device, the panel (cover) 40 containing the aperture or plurality of apertures 45 is configured to lie adjacent and parallel to an outer rim 60 of the lens frame 25 when the device 10 is attached to the night vision instrument 15 and the device is in a closed state 42.

In a further variant of the device 10 for improving the focus of an image produced by a night vision instrument 15, the housing 35 comprises an outside surface 65 configured to conform to an inside surface 70 of the lens frame of the night vision instrument, for attaching the device to the lens frame 25. The housing is configured to hold the front panel containing the aperture or plurality of apertures 45 in parallel spatial relationship with the lens 20, when the device 10 is attached to the lens frame 25.

In still another variant of the device 10 for improving the focus of an image produced by a night vision instrument, the device may include a hinge 75 that connects the panel 40 to the housing 35. The panel 40 containing the aperture or plurality of apertures 45 can be toggled between a closed state 42 and open state 44 by swinging the panel 40 open and shut via the hinge connection 75. Alternatively, the panel 40 containing a plurality of apertures 45 can be toggled between a closed state 42 and open state 44 by positioning a second or a third of the plurality of apertures 45 in front of the lens.

In yet a further variant of the device for improving the focus of an image produced by a night vision instrument, the device has a locking mechanism 80 for locking the panel 40 in the closed state 42.

In another variant of the device for improving the focus of an image produced by a night vision instrument, the locking mechanism 80 comprises a latch 85 configured for hooking the side 90 of the panel 40 opposite the hinge 75 to a mating surface 95 on the housing 35. The locking mechanism 80 is manually lockable and unlockable by a user.

In a further variant of the device 10 for improving the focus of an image produced by a night vision instrument, the device comprises a securing mechanism 100 for securing the device 10 to the night vision instrument 15.

In still another variant of the device 10 for improving the focus of an image produced by a night vision instrument, the securing mechanism 100 is configured to secure the device 10 to the lens frame 25. The securing mechanism comprises a screw 105 for tightening the device 10 against the lens frame 25.

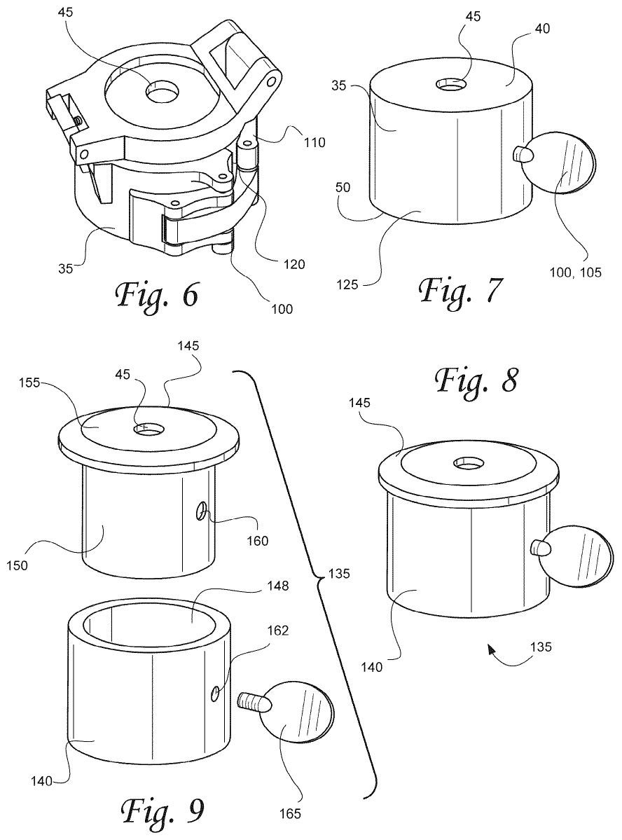

In yet a further variant of the device 10 for improving the focus of an image produced by a night vision instrument, referring to FIG. 6, the securing mechanism 100 may comprise a lever 110 for shortening a circumference of the housing around the lens frame 25 and securing the device to the outer surface 55 of the lens frame 25. The housing has a gap 120 for shortening and lengthening the circumference of the housing 35 and thus, tightening and loosing the attachment of the housing 35 to the lens frame 25.

In another variant of the device for improving the focus of an image produced by a night vision instrument, referring to FIG. 7, the device has a housing 35 configured to attach to the lens frame 20, and the housing comprises: a side 125; a front panel 40 connected to the side 125 and perpendicular to the side 125; and an aperture or plurality of apertures 45 disposed in the front panel 40. When the device 10 for improving an image is attached to the night vision instrument 15, the image captured by the night vision instrument 15 is filtered by the aperture or one of the plurality of apertures 45 and the focus of the image viewed by the user through the night vision instrument is improved.

In a further variant, still referring to FIG. 7, the panel 40 is permanently connected to the side 125 of the housing 35 of the device 10 and permanently oriented perpendicular to the side 125. The device may have a securing mechanism 100 for securing the device to the night vision instrument. The securing mechanism 100 may be configured to secure the device to the lens frame 25 and the securing mechanism 100 may comprise a screw 105 for tightening the device against the lens frame 25.

In still another variant, referring to FIGS. 8-9, the device 10 comprises an assembly 135, comprising a cylinder housing 140 configured to receive an insert 145 in its interior 148. The insert 145 may comprise a side wall 150 and a panel 155 containing an opening or aperture or a plurality of apertures 45. A user may vary the size of the aperture and thus the quality of the focus and the light level in the image, by selecting an insert 145 having a different sized opening or aperture 45 or selecting from a plurality of different size apertures 45 coupled to the insert 145 that can be adjusted to position one or another of the plurality of apertures 45 on the face of the insert 145. The insert may have a first through hole 160 and the cylinder housing 140 may have a second through hole 162 for receiving a thumb screw 165 to both hold the assembly 135 together and to secure the device 10 to the night vision instrument 15. Optionally, the through holes 160, 162 may be threaded and the thumb screw may screw into them. FIG. 8 illustrates the assembly 135 assembled in an operative state, while FIG. 9 illustrates an exploded view of the assembly.

In some embodiments, the assembly illustrated in FIGS. 8-9 is configured to place the panel containing the aperture as close as possible to the lens 20 of a night vision instrument when the assembly is connected to the night vision instrument 15. In one embodiment, this may be achieved by configuring the insert to receive the lens frame 25 of the instrument 15.

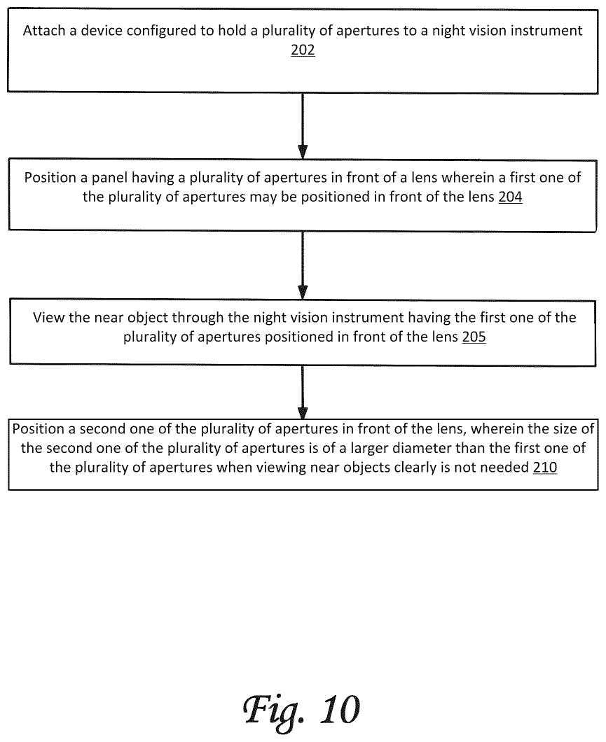

In still another variant, referring to FIG. 10, a method is provided for operating a night vision instrument for viewing a near object, or in other words, objects close to the user of the night vision instrument, when the night vision instrument has a focus optimally set to view distant objects. The method comprises: In a step 202, attaching a device configured to hold a plurality of apertures to a night vision instrument. In a step 204, positioning a panel having the plurality of apertures wherein one of the plurality of apertures may be positioned in front of a lens of the night vision instrument; in a step 205 viewing the near object through the night vision instrument having a first one of the plurality of apertures positioned in front of the lens; and in a step 210 positioning a second one or a third one of the plurality of apertures in front of the lens, wherein the size of at least one of the second one or the third one of the plurality of apertures is of a larger diameter than the first one of the plurality of apertures when viewing near objects clearly or as clearly as using the first one is not needed. In one embodiment, the method comprises either removing the panel from in front of the lens or adjusting the plurality of apertures to position a second aperture or a third aperture having a larger diameter than the first aperture in front of the lens when more light is preferable to an operator than a clearer image. Optionally, an operator may use infrared light while using the night vision instrument with the panel positioned in front of the lens.

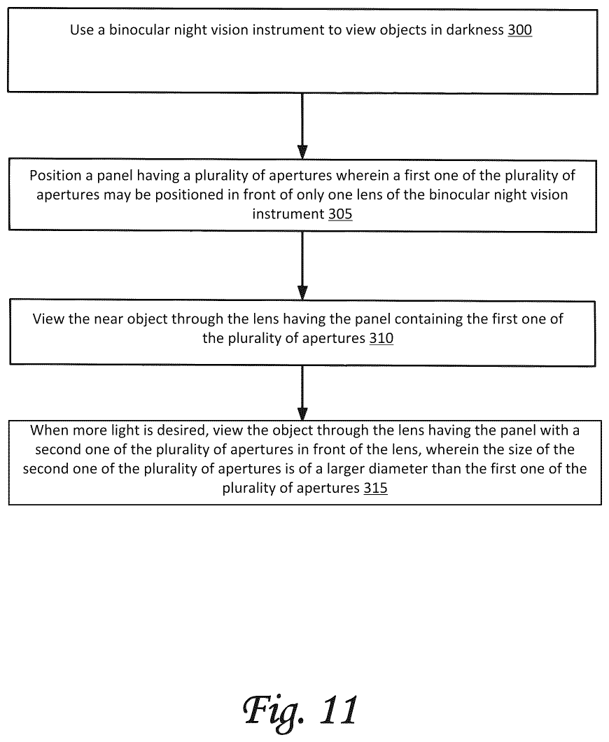

In still another variant, referring to FIG. 11, a method of viewing a dark environment comprises: in a step 300 using a binocular night vision instrument; in a step 305 positioning a panel having a plurality of apertures wherein a first one of the plurality of apertures may be positioned in front of only one lens of the binocular night vision instrument; in a step 310 viewing the near object through the lens having the panel containing the first one of the plurality of apertures; and when more light is desired, viewing the object through the lens having the panel with a second one or a third one of the plurality of apertures in front of the lens, wherein the size of the second one or the third one of the plurality of apertures is of a larger diameter than the first one of the plurality of apertures when viewing near objects clearly or as clearly as the first one is not needed.

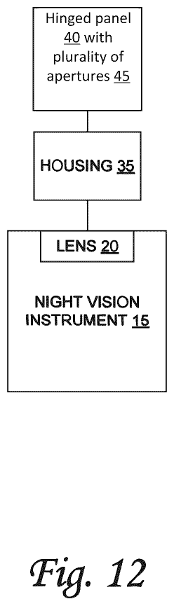

In another variant, referring to FIG. 12, a night vision instrument 15 is provided that contains a hinged panel (cover) 40 having an aperture or a plurality of apertures 45 attached to the lens 20 frame. The panel may be attached to a housing 35 via a hinge 75.

In a further variant of the method of operating a night vision instrument, referring to FIG. 10, the method may comprise a step 202 attaching a device to the night vision instrument. The device is configured for holding the panel having an aperture in a plurality of states which may be selected by an operator of the night vision instrument. A first state comprises positioning a first aperture having a first diameter in front of the lens, a second state comprises positioning a second aperture having a second diameter in front of the lens, and a third state comprises positioning the panel so that the lens is not obscured by the panel.

In another variant of the method of operating a night vision instrument, the step 204 of positioning a panel having a first aperture having a first diameter in front of a lens of the night vision instrument comprises swiveling the panel in front of lens and adjusting the panel to position the first aperture in front of the lens.

In yet a further variant of the method of operating a night vision instrument, the step 210 when viewing near objects clearly is not needed, comprises positioning a second one or a third one of the plurality of apertures in front of the lens, wherein the size of at least one of the second one or the third one of the plurality of apertures is of a larger diameter than the first one of the plurality of apertures. Alternatively, when viewing near objects with a clearer focus is no longer needed, the step 210 comprises removing the panel from in front of the lens by swiveling the panel away from the lens.

In some embodiments of these devices, the cover is manually adjustable between aperture areas. Non-limiting examples of mechanisms that can effect the manual adjustment are electronic switch, lever, knob, spring release, hinge, latch, and rotating bezel. In other embodiments, the device comprises a component that automatically adjusts the cover between aperture areas. Such components are known in the art, for example as are incorporated in camera autofocus features. See, e.g., U.S. Pat. Nos. 4,147,417; 4,425,031; 5,752,106; 7,570,879, each incorporated herein by reference. In those systems, the component uses ultrasonic sound waves, infrared light, or other means to detect the distance of the object from the camera. It is envisioned that the same components can be utilized to assist in the automatic adjustment of the cover between aperture areas based on the distance of the object from the device.

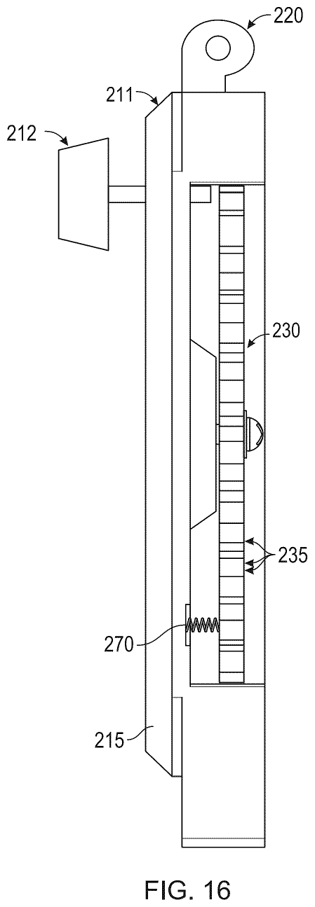

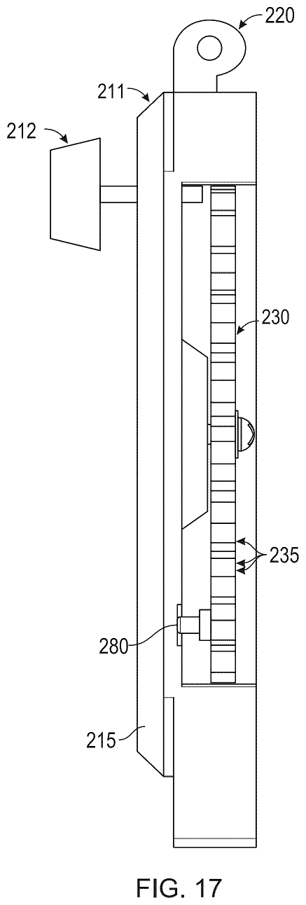

FIG. 15A is another front view of the device illustrating an alternative cover for providing an aperture in accordance with some embodiments of the present disclosure. Depicted in FIG. 15A is the front view 215 of the cover 211. This variant comprises a cover 211 mounted on an instrument lens frame (not shown) via a hinge 220. The aperture 225 is formed by a combination of a hole in the cover 211 and an aperture selection ring 230, where one or more ridges 235 integrated into the aperture selection ring 230 adjust the size of the aperture 225 when the aperture selection ring 230 is rotated such as by physical manipulation by a user of the device. This variant provides multiple fixed aperture sizes, allowing adjustment of aperture size without changing covers. The cross-section line depicted in FIG. 15A identifies the viewpoint of FIGS. 16 and 17.

FIG. 15B is a rear view of the cover 211 illustrating the aperture selection ring 230, the aperture 225, and the first aperture adjustment 240, second aperture adjustment 245, third aperture adjustment 350, and fourth aperture adjustment 255 in accordance with some embodiments of the present disclosure. As illustrated by FIG. 15B, the size of the aperture 225 is adjusted based on the position of the aperture selection ring 230. As the aperture selection ring 230 rotates, the first aperture adjustment 240, second aperture adjustment 245, third aperture adjustment 350, and fourth aperture adjustment 255 will rotate into a position of alignment with the aperture 225. The range of sizes for the first aperture adjustment 240, second aperture adjustment 245, third aperture adjustment 350, and fourth aperture adjustment 255 may be between 0.0625 inches (e.g., the first aperture) and 1.125 inches (e.g., the fourth aperture). However, this size range is not limiting, and any number of aperture adjustments may include more or less adjustments including larger or smaller sizes. For example, in certain embodiments, the aperture is about 1/64 in., about 1/32 in., about 3/64 in., about 1/16 in., about 5/64 in., about 3/32 in., about 7/64 in., about ⅛ in., about 9/64 in., about 5/32 in., about 11/64 in., about 3/16 in., about 13/64 in., about 7/32 in., about 15/64 in., about 4 in., about 17/64 in., about 9/32 in., about 19/64 in., about 5/16 in., about 21/64 in., about 11/32 in., about 23/64 in., about ⅜ in., about 25/64 in., about 13/32 in., about 27/64 in., about 7/16 in., about 29/64 in., about 15/32 in., about 31/64 in., about 1% in., about 33/64 in., about 17/32 in., about 35/64 in., about 9/16 in., about 37/64 in., about 19/32 in., about 39/64 in., about ⅝ in., about 41/64 in., about 21/32 in., about 43/64 in., about 11/16 in., about 45/64 in., about 23/32 in., about 47/64 in., about ¾ in., or any size in between the foregoing or any similar metric size apertures. As illustrated by FIG. 15B, the cover 211 and the aperture selection ring 230 are mechanically coupled by a fastener 260 such as a screw. In some embodiments, the fastener 260 may be a tension spring or a different connector. While FIG. 15B depicts four aperture adjustments, any number of aperture adjustments may be configured to be used.

FIG. 16 is a cross-section of FIG. 15A and illustrates a locking mechanism of the aperture selection ring 230 in accordance with some embodiments of the present disclosure. As illustrated by FIG. 16, the night vision instrument includes the cover 211, the hinge 220, the aperture selection ring 230, ridges 235, and spring 270. The cover includes locking pin 212. The aperture selection ring 230 may be connected to spring 270 using adhesive or a mechanical coupling. As the aperture selection ring 230 is rotated, the spring 270 will be compressed between the cover 211 and the aperture selection ring 230. As the aperture selection ring 230 approaches a position where one of the aperture adjustments aligns with the aperture (as described above), the spring 270 will decompress and provide resistance to further rotation of the aperture selection ring 230. The spring 270 may decompress into a recession or groove in the cover 211. The decompression of the spring 270 may lock the aperture selection ring 230.

The cover 211 may also include the locking pin 212 which is configured to be interactive such that a user can depress the locking pin 212 to produce friction against the aperture selection ring 230. The friction produced by the locking pin 212 may prevent the aperture selection ring 230 from rotation. The locking pin 212 can be engaged independently of the spring 270.

FIG. 17 is another cross-section of FIG. 15A and illustrates an alternative locking mechanism of the aperture selection ring 230 in accordance with some embodiments of the present disclosure. As illustrated by FIG. 16, the night vision instrument includes the cover 211, the hinge 220, the aperture selection ring 230, ridges 235, and pin 280. The cover includes locking pin 212 which is similar to as described above. The aperture selection ring 230 may be connected to pin 280 using adhesive or a mechanical coupling. As the aperture selection ring 230 is rotated, the pin 280 will be compressed between the cover 211 and the aperture selection ring 230. As the aperture selection ring 230 approaches a position where one of the aperture adjustments aligns with the aperture (as described above), the pin 280 will extend into a recession or groove in the cover 211. The extension of the pin 280 provides resistance to further rotation of the aperture selection ring 230.

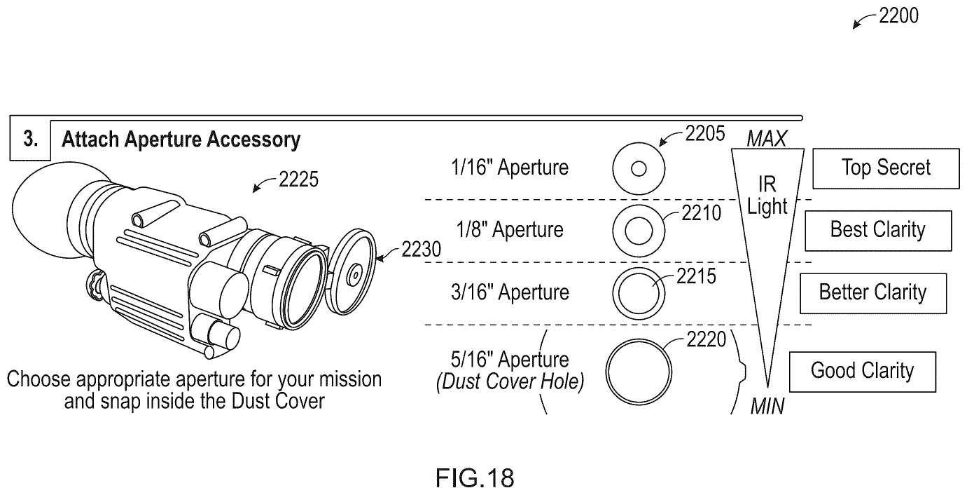

FIG. 18 illustrates an example of an excerpt of a user manual for the night vision instrument 2225. More specifically, FIG. 18 illustrates an aperture accessory 2230 that may be configured to fit an insertable aperture adjustment. For example, the user manual includes a set of aperture adjustments including a first aperture adjustment 2205, second aperture adjustment 2210, third aperture adjustment 2215, and fourth aperture adjustment 2220. In some embodiments, the aperture accessory 2230 is configured to receive any of the first aperture adjustment 2205, second aperture adjustment 2210, third aperture adjustment 2215, or fourth aperture adjustment 2220. The aperture adjustments may be changed by removing a current aperture adjustment from the aperture accessory 2230 and inserting a selected aperture adjustment.

As further illustrated by FIG. 18, the manual includes a guide for an amount of infrared (IR) light available and a corresponding clarity when using a selected aperture adjustment. For example, in an environment with a moderate amount of IR light using the second aperture 2210, the clarity will have a characteristic of “best clarity” for the set of conditions. In some embodiments, the aperture accessory 2230 can be configured to include the aperture selection ring as described above.

Any of the above-described devices can further comprise an infrared light source to assist in visualizing objects. See Example 1, establishing that infrared light can improve visual clarity.

The devices described above can incorporate an electric motor to rotate the aperture selection ring. The rotation can occur automatically depending on a detected focal range or distance to the object being viewed.

Also provided herewith is a night vision instrument comprising any of the above-described devices. In some embodiments, the device is separable from the instrument. In other embodiments, the instrument lens frame incorporates the housing. In additional embodiments, the housing is permanently affixed to the lens frame, such that the device is integrated into the night vision instrument.

### Example 1. Effect of Aperture Size and Incident Infrared on Ability to Focus Through a Night Vision Instrument

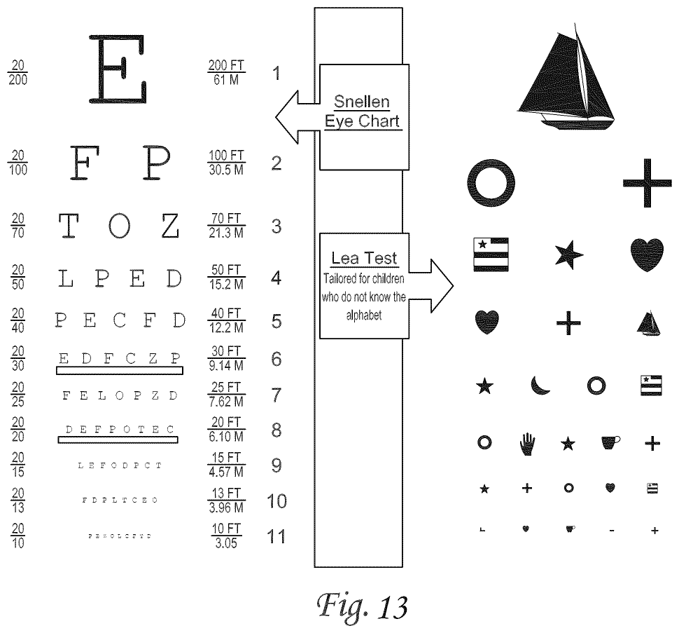

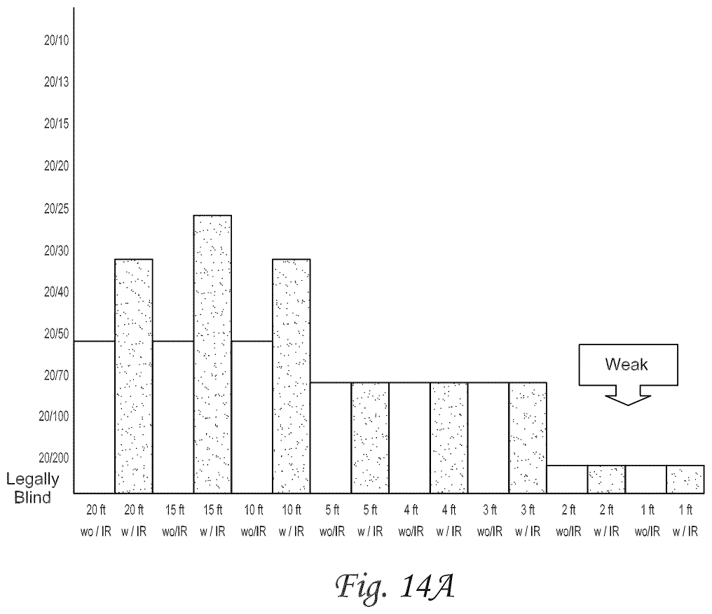

Night vision goggles were used to evaluate the ability to focus on either a Snellen eye chart, or a Lea test (FIG. 13) at various distances (1, 2, 3, 4, 5, 10, 15 and 20 feet), and in the presence or absence of infrared light. In some tests, a rubber washer, 1/16″ thick, with a drilled hole for the aperture, was placed on one lens of the goggles to determine the effect of the aperture on the ability to focus. The aperture diameters tested were 1/16″, ⅛″, and 13/64″.

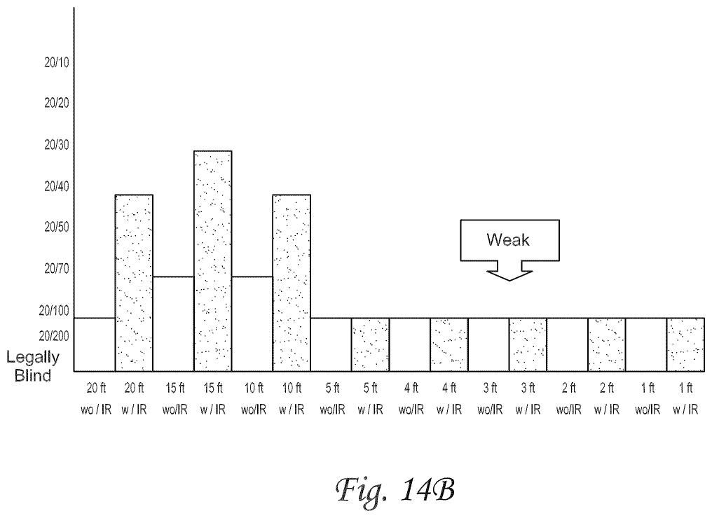

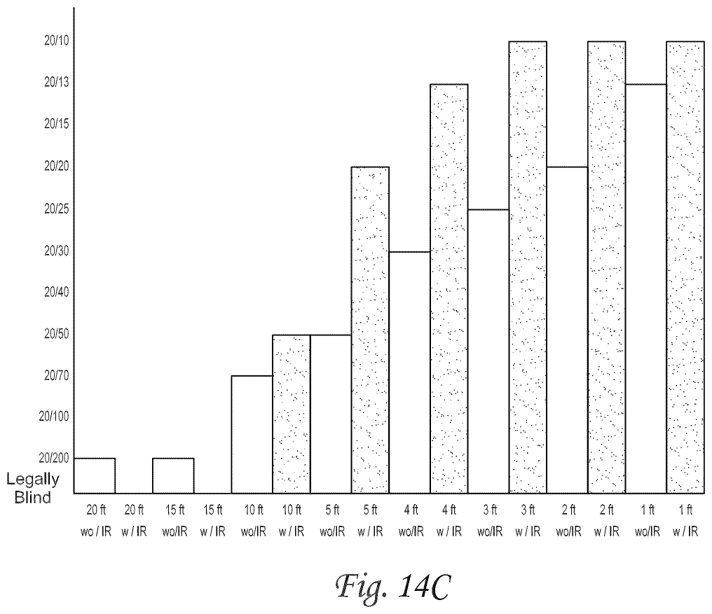

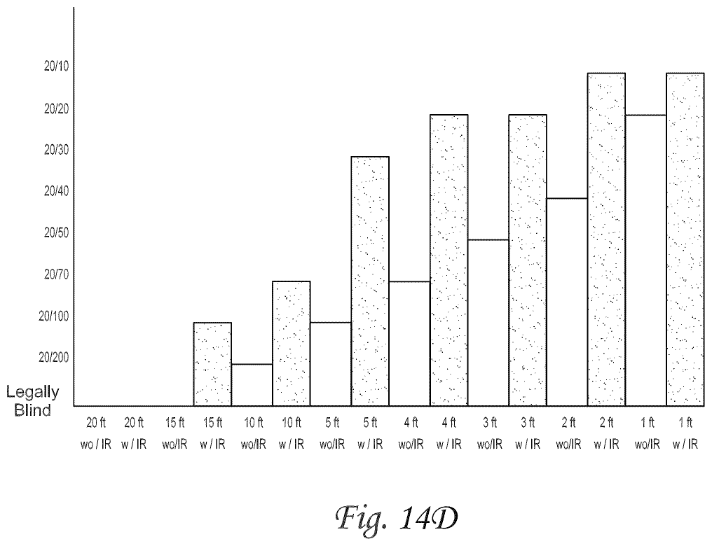

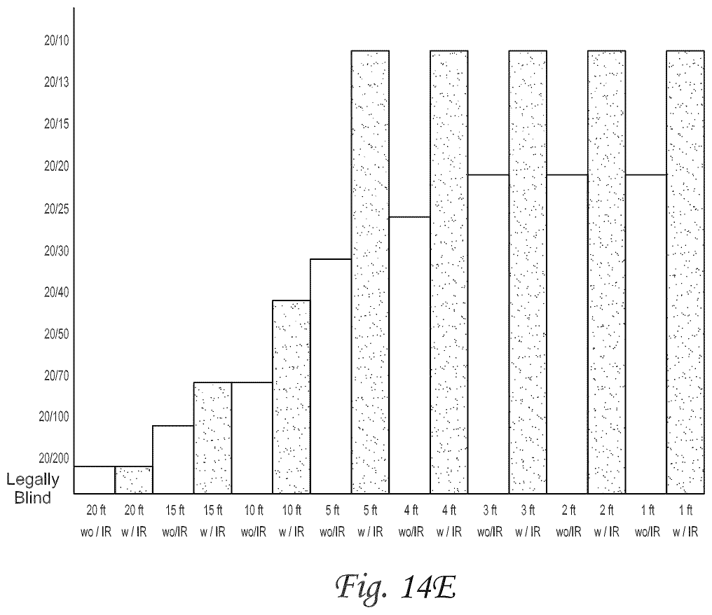

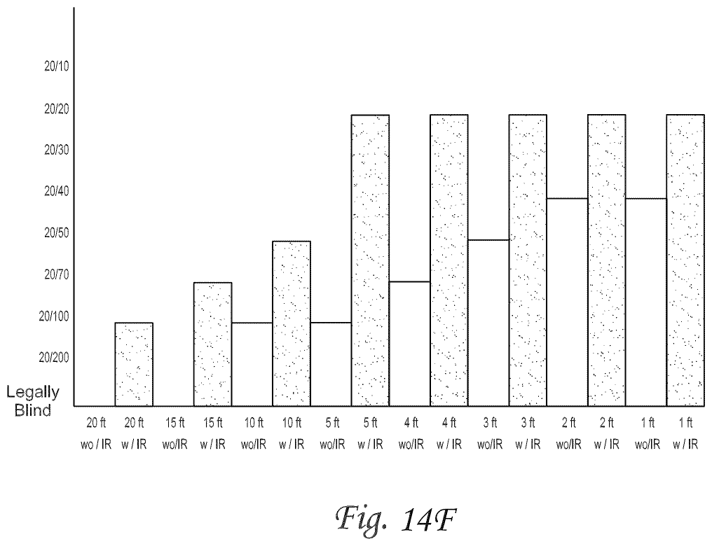

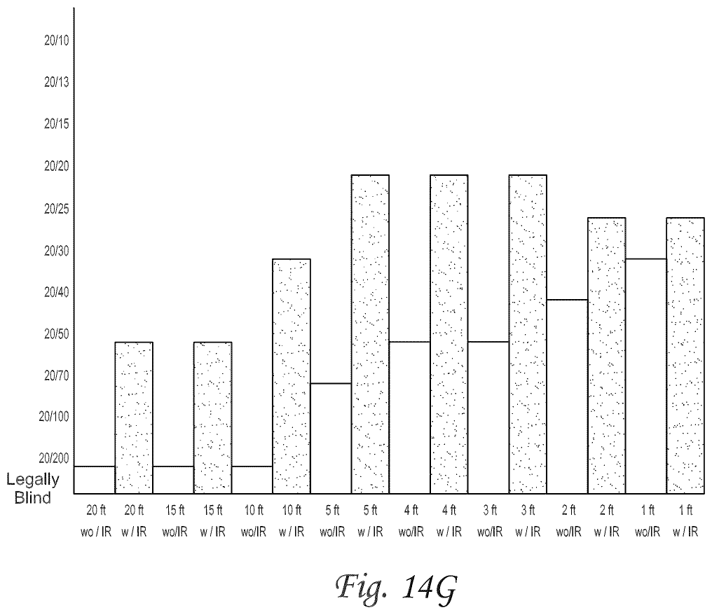

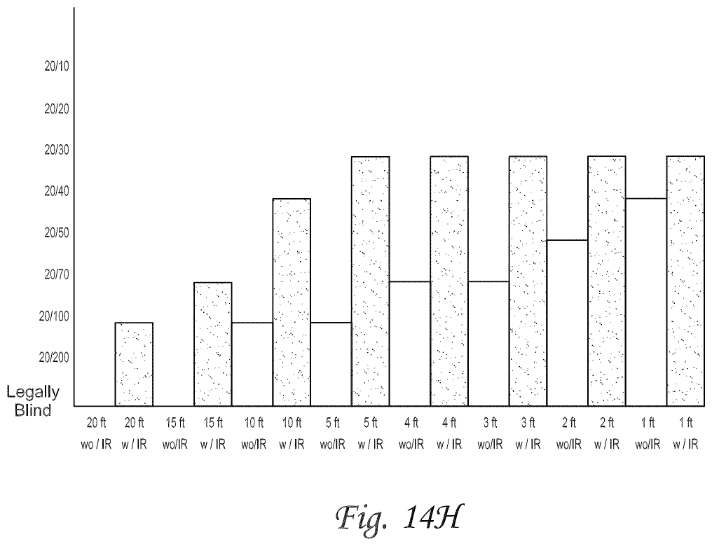

FIGS. 13A and B shows the results when no cover was used to modify the aperture area. Visual clarity was generally better with the Snellen chart (FIG. 14A) than with the Lea test (FIG. 14B). With both tests, infrared light aided visual clarity at 10 ft. or greater. Visual clarity was poor at 5 ft. or less.

When an aperture having a diameter of 1/16″ was used, visual clarity at 5 ft or less was greatly improved with both the Snellen chart (FIG. 14C) and the Lea test (FIG. 14D) over the corresponding tests using no cover to modify the aperture area. At those distances, infrared light aided the visual clarity.

An aperture of ⅛″ also greatly improved visual clarity at 5 ft. or less (FIG. 14E, F) over the corresponding no aperture tests. However, at the shortest distance (1 ft.), the 1/16″ aperture was superior to the ⅛″ aperture. Conversely, the ⅛″ aperture provided visual clarity superior to the 1/16″ aperture at the 5 and 10 ft. distance, particularly when infrared light was utilized. Infrared light greatly aided clarity at 5 ft or less.

When the 13/64″ aperture was used (FIG. 14G, H) visual clarity at all distances was similar to the results with the ⅛″ aperture when the Lea test was used. However, when the Snellen chart was used, the 13/64″ aperture provided inferior visual clarity at 5 ft. or less but superior visual clarity at 10 ft. or greater, particularly when infrared light was used.

### Example 2. Effect of Aperture Distance from Lens on Field of View Width

A 13/64″ aperture, as used in the tests described in Example 1, was placed over a night vision instrument lens at a distance from the lens of 2/16″, 3/16″, ¼″, 6/16″, ½″, and 10/16″. The 2/16″ distance was achieved by placing the aperture-bearing washer on the lens frame, which protruded beyond the plane of the lens by 2/16″. The other distances were achieved by stacking washers that were 1/16″ thick between the aperture and the lens frame. The width of the field of view (horizontal field of view) was measured at 1, 2, 3, 4, 5, 10, 15 and 20 feet. The measurements are provided in Table 1. The ¼″ and ½″ measurements are not provided because they were the same in all cases as the 6/16″ and 10/16″ measurements, respectively.

FIG. 1. Horizontal field of view at various distances through a night vision instrument having a 13/64″ aperture spaced at various distances from the lens.

| | Distance from instrument - feet | | | | | | | | |
|---|---|---|---|---|---|---|---|---|---|
| | | 1 | 2 | 3 | 4 | 5 | 10 | 15 | 20 |
| Aperture | 2/16 | 11 in. | 22 in. | 26 in. | 40 in. | 50 in. | 13 ft | 12 ft. | 15 ft. |
| distance | 3/16 | 10 in. | 20 in. | 24 in. | 35 in. | 47 in. | 12 ft | 11 ft. | 13.5 ft. |
| from | 6/16 | 9 in. | 18 in. | 22 in. | 33 in. | 41 in. | 11.5 ft | 10 ft. | 12.5 ft. |
| lens | 10/16 | 8 in. | 16 in. | 20 in. | 31 in. | 38 in. | 11 ft | 9.5 ft. | 11.5 ft. |
| [symbol] | | | | | | | | | |

[symbol]

indicates data missing or illegible when filed

As expected, the horizontal field of view increases with increasing distance from the instrument and decreasing aperture distance from the lens.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether CTRL logic or other components, can be combined in a single package or separately maintained and can further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

All references cited in this specification are hereby incorporated by reference. The discussion of the references herein is intended merely to summarize the assertions made by the authors and no admission is made that any reference constitutes prior art. Applicants reserve the right to challenge the accuracy and pertinence of the cited references.

What is claimed is:

1. A device for improving the focus of an object viewed using a night vision instrument, the night vision instrument comprising an instrument lens, a lens frame comprising a distal end, and night vision components, the device comprising:
a housing configured to couple to the distal end of the lens frame; and
a cover coupled to the housing, wherein, when the housing is coupled to the lens frame, the cover is rotatably adjustable to define a plurality of apertures allowing light to the lens, the apertures being variable between having at least a first area and a second area, the first area being smaller than the second area, and wherein when the device is coupled to the night vision instrument, the visual clarity of the object viewed through the instrument and device is superior to the visual clarity of the object when viewed using the instrument without the device, when the object is within 3 feet of the device and the aperture has the first area or the second area.

2. The device of claim 1, wherein the aperture having the first area is circular.

3. The device of claim 1, wherein the aperture having the first area is not circular.

4. The device of claim 1, wherein the cover is circular.

5. The device of claim 1, wherein the cover is not circular.

6. The device of claim 1, wherein the cover comprises an opening having a third area, the cover further comprising at least one hinge coupling the cover to the housing, wherein the superior visual clarity is achieved by swinging the cover over the instrument lens frame to allow light to the instrument lens having the first area, and the aperture having the second area is achieved by rotating a portion of the cover, and
wherein the second area is different than the first area.

7. The device of claim 6, wherein the cover comprises at least two sections, each section comprising a hinge coupling the section to the housing, wherein the superior visual clarity is achieved by swinging the sections over the lens frame to allow light to the instrument lens having the first area or the second area.

8. The device of claim 1, wherein the housing comprises a ring and the cover comprises a rotatable portion that forms the aperture, wherein the rotatable portion includes a device for fixing each of a plurality of positions of the rotatable portion.

9. The device of claim 1, wherein the cover includes a locking mechanism that prevents rotation of the rotatable portion.

10. The device of claim 1, wherein the first area has a maximum diameter of about 13/64″ or less.

11. The device of claim 1, wherein the first area has a maximum diameter of about ⅛″ or less.

12. The device of claim 1, wherein the second area has an area less than or greater than the first area.

13. The device of claim 1, wherein the cover is about 10/16″ or less from the instrument lens.

14. The device of claim 1, wherein the cover is about 3/16″ or less from the instrument lens.

15. The device of claim 1, wherein the cover is disposed at the distal end of the lens frame.

16. The device of claim 1, wherein the cover is manually adjustable between aperture areas.

17. The device of claim 16, wherein the manual adjustment is by electronic switch, lever, knob, spring release, hinge, latch, or rotating bezel.

18. The device of claim 1, further comprising a component that automatically adjusts the cover between aperture areas.

19. The device of claim 18, wherein the component that automatically adjusts the cover between aperture areas uses ultrasonic sound waves or infrared light to detect the distance of the object from the device.

20. The device of claim 1, further comprising an infrared light source.

21. A night vision instrument comprising the device of claim 1.

22. The night vision instrument of claim 21, wherein the lens frame incorporates the housing.

23. The night vision instrument of claim 21, wherein the housing is permanently affixed to the lens frame.
